(19) United States
(12) Patent Application Publication
(10) Pub. No.: US 2002/0152980 A1
(43) Pub. Date: Oct. 24, 2002

(54) Starting and/or positioning system and method

(76) Inventors: Peter Ahner, Boeblingen (DE); Manfred Ackerman, Oppenweiler (DE)

Correspondence Address: Michael J Striker, Striker Striker & Stenby, 103 East Neck Road, Huntington, NY, 11743, US

(21) Appl. No.: 09/937,891

(22) PCT Filed: Jan. 26, 2001
(86) PCT No.: PCT/DE01/00306

(30) Foreign Application Priority Data
Feb. 22, 2000 (DE) 100 07 956.3

(51) Int. Cl. F02N 11/00

(52) U.S. Cl. 123/179.3; 123/179.25

(57) ABSTRACT

The invention concerns a system and a method for starting and/or positioning an internal combustion engine ICE, whereby an electric machine S/G is provided that is connected by way of a spring-and-damper assembly S/D to the internal combustion engine having a total start-up torque T1.

It is provided that the electric machine S/G is controlled by a circuit in such a way that the electic machine activates the spring-and-damper assembly S/D with a torque T2 in a wave form, the amplitude of which is smaller than the total start-up torque T1, and that the spring-and-damper assembly S/D—at least in a steady-state condition—transmits a torque T3 to the internal combustion engine ICE, the amplitude of which is greater than or equal to the total start-up torque T1.

The invention concerns a system for starting and/or positioning an internal combustion engine having the features named in the preamble of claim 1.

The invention further concerns a method for starting and/or positioning an internal combustion engine having the features named in the preamble of claim 16.

### RELATED ART

In a vehicle with direct drive, starting an internal combustion engine requires a propulsion system that is dimensioned for the cold-starting limit temperature, which is generally considered to be −25° C. Even at this cold-starting limit temperature, the total start-up torque must be overcome to start the internal combustion engine. The total start-up torque is influenced, among other things, by the drag torque, the pneumatic spring torque, and the accelerating torques of the internal combustion engine. This total start-up torque can amount to 200 Nm, for example, in a typical standard-size automobile.

To reduce fuel consumption, it is already known that the internal combustion engine can be shut off when the vehicle comes to a temporary standstill, at a stop light, for example, and then restarted shortly before or when the vehicle is driven further, resulting in start-stop operation.

Furthermore, a parallel hybrid power system can effect a shutting down/disengagement of the internal combustion engine in trailing throttle phases.

New vehicle functions of this nature, as well as the greatly increased demands on the electrical performance of the vehicle electrical system, led to the development of the starter-generator, an electric machine that can be used as a starter as well as a generator. Moreover, it is already known that the internal combustion engine can be pre-positioned before starting so that the intrinsic potential in the internal combustion engine can be better utilized in the starting procedure.

Particularly when the electric machine is a starter-generator, it is essential that the torque required of the electric machine be reduced to the extent that the current required in the generator mode also suffice for start-up. In other words, the extent of work performed by the electric machine and the inverter must be minimized with regard for the starting function as well as the generator function.

The “pulse start” has already been proposed for this purpose. To perform a pulse start, the internal combustion engine is connected by way of a pulse-start coupling to the starter-generator, which, in turn, is connected to the vehicle transmission by way of a clutch.

The start is carried out in such a way that, with the pulse-start coupling open and the vehicle clutch open, the inertia weight of the starter-generator is accelerated to the “wind-up speed” by the starter-generator. When this wind-up speed is reached, the pulse-start coupling is closed, while the vehicle clutch remains open. As a result, the internal combustion engine is accelerated rapidly by way of the coupling torques until the clutch sticks, with the electromotive torques then preventing the internal combustion engine from coming to a standstill too quickly.

Using the pulse-start method, the internal combustion engine can also be started successfully when the driving torque of the electric machine amounts to only 50% of the total start-up torque. The level of driving torque required of the electric machine thereby depends on the design of the clutch and further basic vehicle conditions, such as the fuel-injection technology and transmission type.

In comparison, “direct crankshaft starting” requires that the electric machine produce a driving torque that amounts to approximately 140% of the total start-up torque.

The pulse-start coupling is very expensive, because it must be designed to accommodate the maximum vehicle working torque and a portion of the pulsating torques of the internal combustion engine. Moreover, the fuel-injection technology must be redesigned for the high dynamics of the pulse start.

### ADVANTAGES OF THE INVENTION

Due to the fact that the electric machine in the system according to the invention is controlled by a circuit in such a way that the electric machine activates the spring-and-damper assembly with a torque in a wave form, the amplitude of which is smaller than the total start-up torque, and that the spring-and-damper assembly—at least in a steady-state condition—transmits a torque to the internal combustion engine, the amplitude of which is greater than or equal to the total start-up torque, the expensive pulse-start coupling can be eliminated.

The same applies for the method according to the invention, in which control of the electric machine is carried out in such a way that the electric machine activates the spring-and-damper assembly with a torque in a wave form, the amplitude of which is smaller than the total start-up torque, and in which the spring-and-damper assembly—at least in a steady-state condition—transmits a torque to the internal combustion engine, the amplitude of which is greater than or equal to the total start-up torque.

In the system according to the invention, it is advantageous when the torque with which the electric machine activates the spring-and-damper assembly in a wave form has a positive value when the speed of the electric machine is positive.

In this context, “positive speed” means a speed produced when the internal combustion engine is running, at which the direction of rotation of the electric machine is the same as the direction of rotation of the crankshaft of the internal combustion engine.

The positive value of the torque with which the electric machine activates the spring-and-damper assembly in a wave form is preferably a constant value.

The torque with which the electric machine activates the spring-and-damper assembly preferably has a negative value when the speed of the electric machine is negative.

In this context, “negative speed” of the electric machine means a speed produced when the internal combustion engine is running, at which a direction of rotation of the electric machine occurs that is opposite to the direction of rotation of the crankshaft.

Moreover, it can be advantageous when the torque with which the electric machine activates the spring-and-damper assembly has a negative value when the speed of the electric machine is negative and the speed of the crankshaft of the internal combustion engine is greater than or equal to zero.

It is also feasible that the torque with which the electric machine controls the spring-and-damper assembly have a negative value when the speed of the electric machine is negative, the speed of the crankshaft of the internal combustion engine is greater than or equal to zero, and the torque that the spring-and-damper assembly transmits to the internal combustion engine is less than a specified value.

The negative value of the torque with which the electric machine activates the spring-and-damper assembly can also be a constant value.

When the speed of the electric machine is negative, the torque with which the electric machine activates the spring-and-damper assembly is preferably brought to a positive value when the speed of the crankshaft is less than zero.

To estimate the torque, a model calculation is preferably used that takes into account the speed of the crankshaft of the internal combustion engine, the speed of the electric machine, and the characteristic curve of the spring of the spring-and-damper assembly.

The spring-and-damper assembly preferably has a spring that is progressive when torsion is positive.

The electric machine can have a rotor that forms the secondary mass of a dualmass flywheel.

A first speed sensor is preferably provided that detects the speed of the crankshaft of the internal combustion engine.

A second speed sensor can detect the speed of the electric machine.

The output signal of the first speed sensor and/or the output signal of the second speed sensor is preferably fed to the circuit.

The electric machine is preferably connected to a vehicle transmission by way of a clutch.

In the method according to the invention it is also advantageous when the torque with which the electric machine activates the spring-and-damper assembly has a positive value when the speed of the electric machine is positive.

In this context as well, “positive speed” means positive speed as defined above.

This positive value of the torque with which the electric machine activates the spring-and-damper assembly is preferably a constant value.

In the method according to the invention, it can also be provided that the torque with which the electric machine activates the spring-and-damper assembly have a negative value when the speed of the electric machine is negative.

In this context as well, “negative speed” means negative speed as defined above.

In the method according to the invention, it can also be provided that the torque with which the electric machine activates the spring-and-damper assembly have a negative value when the speed of the electric machine is negative, and the speed of the crankshaft of the internal combustion engine is greater than or equal to zero.

It can also be provided that the torque with which the electric machine activates the spring-and-damper assembly have a negative value when the speed of the electric machine is negative, the speed of the crankshaft of the internal combustion engine is greater than or equal to zero, and the torque that the spring-and-damper assembly transmits to the internal combustion engine is less than a specified value.

The negative value of the torque can be a constant value in the method according to the invention as well.

It can also be provided that, when the speed of the electric machine is negative, the torque with which the electric machine activates the spring-and-damper assembly be brought to a positive value when the speed of the crankshaft of the internal combustion engine is less than zero.

In the method according to the invention, a model calculation is used to estimate the torque that takes into account the speed of the crankshaft of the internal combustion engine, the speed of the electric machine, and the characteristic curve of the spring of the spring-and-damper assembly.

### DIAGRAMS

An embodiment of the invention is described in greater detail below using the associated diagrams.

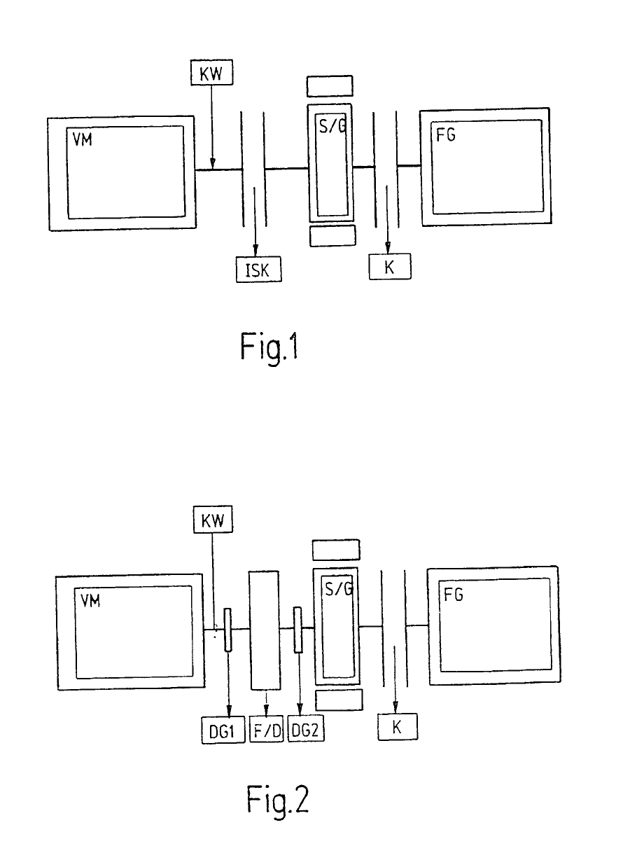

FIG. 1 shows a known system for pulse-starting an internal combustion engine;

FIG. 2 shows a schematic representation of an embodiment of the system according to the present invention;

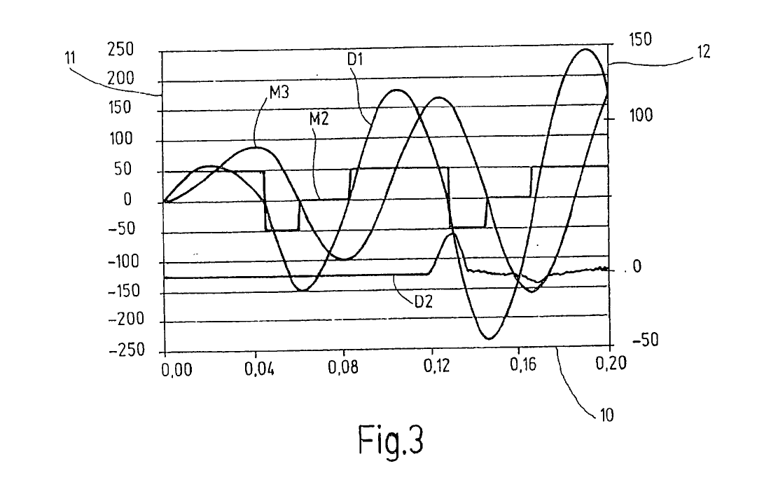

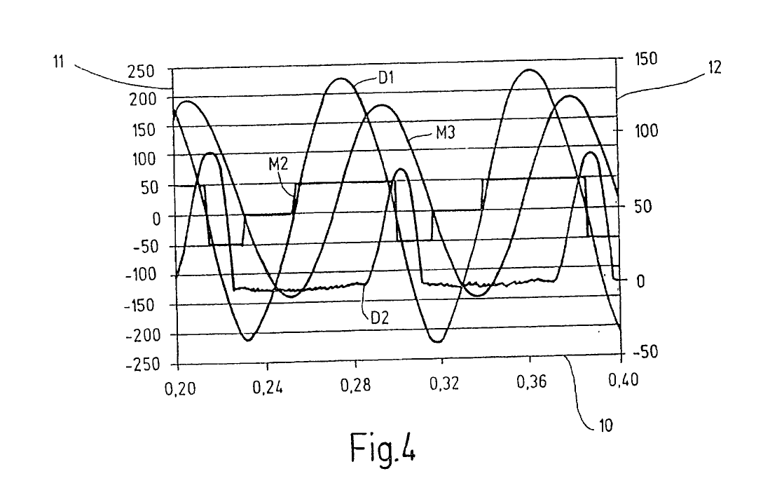

FIG. 3 shows the curve shape of the torque with which the electric machine activates the spring-and-damper assembly, the curve shape of the torque that the spring-and-damper assembly transmits to the internal combustion engine, the curve shape of the speed of the crankshaft of the internal combustion engine, and the curve shape of the speed of the electric machine, for the range in which build-up takes place;

FIG. 4 shows the curve shape of the torque with which the electric machine activates the spring-and-damper assembly, the curve shape of the torque that the spring-and-damper assembly transmits to the internal combustion engine, the curve shape of the speed of the crankshaft of the internal combustion engine, and the curve shape of the speed of the electric machine, for the range of quasi-stationary propulsion;

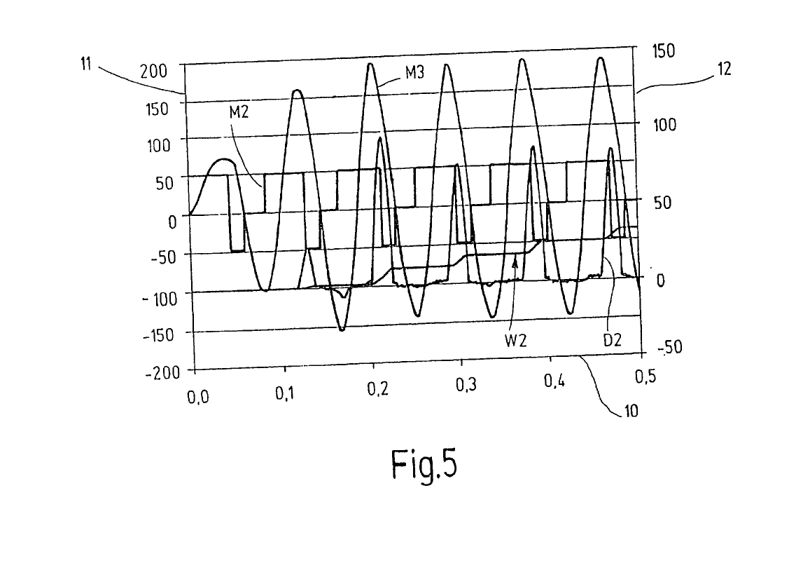

FIG. 5 shows the curve shape of the torque with which the electric machine activates the spring-and-damper assembly, the curve shape of the torque that the spring-and-damper assembly transmits to the internal combustion engine, the curve shape of the speed of the crankshaft of the internal combustion engine, and the curve shape of the angle of rotation of the crankshaft of the internal combustion engine for the range in which build-up takes place;

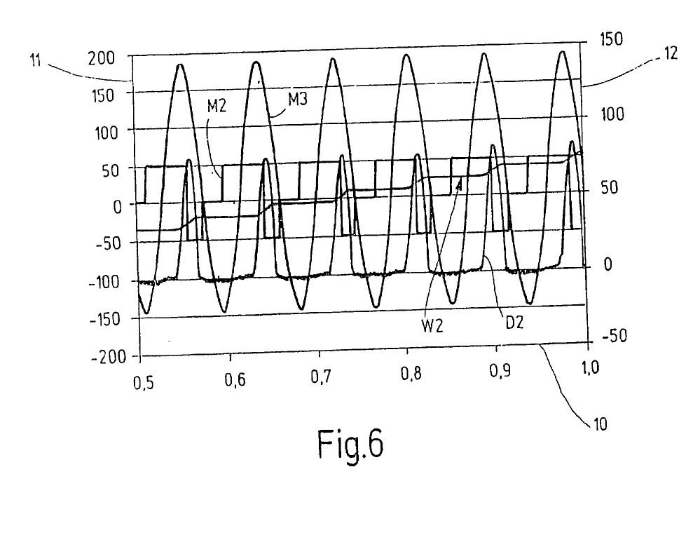

FIG. 6 shows the curve shape of the torque with which the electric machine activates the spring-and-damper assembly, the curve shape of the torque that the spring-and-damper assembly transmits to the internal combustion engine, the curve shape of the speed of the crankshaft of the internal combustion engine, and the curve shape of the angle of rotation of the crankshaft of the internal combustion engine for the range of quasi-stationary propulsion;

In FIGS. 3 through 6, time is plotted in seconds on the horizontal axis 10. Torque is plotted in Nm on the left vertical axis 11, and speed is plotted in I/min on the right vertical axis 12. In FIGS. 5 and 6, the angle of rotation of the crankshaft is also indicated in ° on the right vertical axis 12.

FIG. 1 shows a known system for starting an internal combustion engine ICE that is connected by way of a pulse-start coupling PSC to an electric machine in the form of a starter-generator S/G. The starter-generator S/G is connected to vehicle transmission by way of a clutch C.

In the system depicted in FIG. 1, the internal combustion engine is started in the fashion described at the beginning.

### DESCRIPTION OF THE DESIGN EXAMPLE

An embodiment of the present invention is shown in FIG. 2. The crankshaft CS of an internal combustion engine ICE is connected by way of a spring-and-damper assembly S/D to an electric machine in the form of a starter-generator S/G. The speed S2 of the crankshaft CS of the internal combustion engine ICE is detected using a first speed sensor SS1. Likewise, the speed S1 of the starter-generator S/G is detected using a second speed sensor SS2.

The starter-generator S/G is connected by way of a clutch C with a vehicle transmission VT, with the clutch C preferably opened during the starting or positioning procedure.

Regardless of whether the electric machine is present in the form of a starter-generator S/G or not, the electric machine can be a machine with or without reduction gears.

In this embodiment, the positioning and/or starting of the internal combustion engine ICE takes place using a kind of drive of the electric machine S/G with periodic vibration excitation and torque transmission by way of the spring-and-damper assembly S/D.

The spring-and-damper assembly S/D can either be a torsion spring-and-damper assembly present anyway to dampen drive train vibrations, or a modified design of this assembly.

In this case, the electric machine S/G is controlled in-phase in connection with the spring-and-damper assembly S/D, whereby the vibration is excited to the extent that the internal combustion engine ICE is started in periodic time phases by way of the torsion spring of the spring-and-damper assembly S/D.

A positive torque T2 of the starter-generator S/G suffices to control the excitation. In the boundary region, however, where torques T2 produced by the starter-generator S/G are extremely small compared to the total start-up torque T1, positive and negative torques T2 are more favorable.

As mentioned, the speed S2 of the crankshaft CS of the internal combustion engine ICE is detected by a first speed sensor SS1, while the speed S1 of the electric machine S/G is detected by a second speed sensor SS2.

The spring torque can be estimated using the following arithmetic model:

T_{spring}=ΔΦ*C_{spring}(ΔΦ)

Whereby:

ΔΦ=ƒΔωdt

Whereby Δω is the difference between the speed S2 of the crankshaft CS of the internal combustion engine ICE and the speed S1 of the electric machine S/G.

In this arithmetic model, all energy-related variables are monitored constantly. This makes it possible to control the drive of the electric machine in the form of a starter-generator S/G according to the following rules:

1. First of all, the vibration can be positively excited in both directions of rotation of the starter-generator S/G when bipolar control (via addition of energy) is present;

1.1 When the speeds of the starter-generator S/G are positive, positive torques T2 of the starter-enerator S/G are used;

1.2 When the speeds of the starter-generator S/G are negative—which negative speeds are limited in duration—negative torques T2 of the starter-generator S/G are used;

2. When the values of the spring torque T3 are negative, the starter-generator S/G must be braked in timely fashion in order to prevent the internal combustion engine ICE from reversing.

FIGS. 3 and 4 show the courses of the torque T2 with which the electric machine S/G activates the spring-and-damper assembly S/D, the course of the torque T3 that the spring-and-damper assembly S/D transmits to the internal combustion engine ICE, the speed S1 of the electric machine S/G, as well as the speed S2 of the crankshaft CS of the internal combustion engine ICE.

FIGS. 5 and 6 show the same curves, with the exception that the angle of rotation A1 of the crankshaft is shown instead of the speed S1 of the electric machine S/G.

The curves apply for an internal combustion engine having a total start-up torque T1 of 150 Nm. This corresponds to the total start-up torque of a standard-size automobile at −25° C. The torque T2 with which the electric machine S/G activates the spring-and-damper assembly corresponds to 50 Nm in the case used as the example.

The torsional rigidity and the damping values of the spring-and-damper assembly S/D were specified based on values of spring-and-damper systems that are used to disengage the pulsating torques of the internal combustion engine ICE between the internal combustion engine ICE and the vehicle transmission VT.

When the electric machine in the form of a starter-generator S/G is started and the clutch C is open, the internal combustion engine ICE stalls at first due to static friction. As a result, the starter-generator S/G lifts the torsion bar against the static torque.

The torque T2 with which the starter-generator activates the spring-and-damper assembly S/D is always driven fully in excitation when the speed S1 of the starter-generator is positive, while only the phase with positive torsional torque is used when the speed S1 is negative.

To reduce frictional loss, the starter-generator S/G was only controlled with full positive or negative torque T2, or with a torque of zero.

In FIG. 3, torque T3, which the spring-and-damper assembly S/D transmits to the internal combustion engine ICE, exceeds the value of the total start-up torque T1 at the 0.12-second mark for the first time. As a result, the crankshaft is turned for the first time at this instant, as depicted in the curve shape S2.

In the next negative half-cycle, the crankshaft CS turns back very slightly for a brief instant. This does not cause disruption here, however.

This slight turning back of the crankshaft CS can also be prevented using a brief triggering of the starter-generator S/G in the opposite phase, if this is advantageous.

FIGS. 4 and 6 show how the vibration stabilizes, and that a quasi stationary, pulsed forward motion of the crankshaft CS is achieved beginning at approximately 0.5 seconds, whereby the pulse frequency is approximately 12 Hz in this context and automatically adapts to the value of the intrinsic frequency of the torsional-vibration damper.

The determined speed of the crankshaft CS also results from the curve of the angle of rotation A2, with a speed of 22 l/minute being achieved in the case shown.

The limits of the torque produced by the starter-generator S/G for performing an act of positioning in the desired direction of rotation are below the total start-up torque T1 by a factor of approximately 5 when dampings are present that are common when a dual-mass flywheel is used. This can also be illustrated using a simulation calculation.

1. System for starting and/or positioning an internal combustion engine (ICE), with an electric machine (S/G) connected by way of a spring-and-damper assembly (S/D) to the internal combustion engine having a total start-up torque (T1), characterized in that the electric machine (S/G) is controlled by a circuit in such a way that the electric machine (S/G) activates the spring-and-damper assembly (S/D) with a torque (T2) in a wave form, the amplitude of which is smaller than the total start-up torque (T1), and that the spring-and-damper assembly (S/D)—at least in a steady-state condition—transmits a torque (T3) to the internal combustion engine (ICE), the amplitude of which is greater than or equal to the total start-up torque (T1)

2. System according to claim 1, characterized in that the torque (T2) has a positive value when the speed (S1) of the electric machine (S/G) is positive.

3. System according to one of the preceding claims, characterized in that the positive value of the torque (T2) is a constant value.

4. System according to one of the preceding claims, characterized in that the torque (T2) has a negative value when the speed (S1) of the electric machine (S/G) is negative.

5. System according to one of the preceding claims, characterized in that the torque (T2) has a negative value when the speed (S1) of the electric machine (S/G) is negative and the speed (S2) of the crankshaft (CS) of the internal combustion engine (ICE) is greater than or equal to zero.

6. System according to one of the preceding claims, characterized in that the torque (T2) has a negative value when the speed (S1) of the electric machine (S/G) is negative, the speed (S2) of the crankshaft (CS) of the internal combustion engine (ICE) is greater than or equal to zero, and the torque (T3) is less than a specified value.

7. System according to one of the preceding claims, characterized in that the negative value of the torque (T2) is a constant value.

8. System according to one of the preceding claims, characterized in that, when the speed (S1) of the electric machine (S/G) is negative, the torque (T2) is brought to a positive value when the speed (S2) of the crankshaft (CS) of the internal combustion engine (ICE) is less than zero.

9. System according to one of the preceding claims, characterized in that a model calculation is used to estimate the torque (T3) that takes into account the speed (S2) of the crankshaft (CS) of the internal combustion engine (ICE), the speed (S1) of the electric machine (S/G), and the characteristic curve of the spring of the spring-and-damper assembly (S/D).

10. System according to one of the preceding claims, characterized in that the spring-and-damper assembly (S/D) has a spring that is progressive when torsion is positive.

11. System according to one of the preceding claims, characterized in that the electric machine (S/G) has a rotor that forms the secondary mass of a dual-mass flywheel.

12. System according to one of the preceding claims, characterized in that a first speed sensor (SS1) is provided that detects the speed (S2) of the crankshaft (CS) of the internal combustion engine (ICE).

13. System according to one of the preceding claims, characterized in that a second speed sensor (SS2) is provided that detects the speed (S1) of the electric machine (S/G).

14. System according to one of the preceding claims, characterized in that the output signal of the first speed sensor (SS1) and/or the output signal of the second speed sensor (SS2) is fed to the circuit.

15. System according to one of the preceding claims, characterized in that the electric machine (S/G) is connected to a vehicle transmission (VT) by way of a clutch (C).

16. Method for starting and/or positioning an internal combustion engine (ICE) that comprises the control of an electric machine (S/G) connected by way of a spring-and-damper assembly (S/D) to an internal combustion engine (ICE) having a total start-up torque (T1), characterized in that the control takes place in such a way that the electric machine (S/G) activates the spring-and-damper assembly (S/D) with a torque (T2) in a wave form, the amplitude of which is smaller than the total start-up torque T1, and that the spring-and-damper assembly (S/D)—at least in a steady-state condition—transmits a torque (T3) to the internal combustion engine (ICE), the amplitude of which is greater than or equal to the total start-up torque (T1).

17. Method according to claim 16, characterized in that the torque (T2) has a positive value when the speed (S1) of the electric machine (S/G) is positive.

18. Method according to one of the claims 16 or 17, characterized in that the positive value of the torque (T2) is a constant value.

19. Method according to one of the claims 16 through 18, characterized in that the torque (T2) has a negative value when the speed (S1) of the electric machine (S/G) is negative.

20. Method according to one of the claims 16 through 19, characterized in that the torque (T2) has a negative value when the speed (S1) of the electric machine (S/G) is negative and the speed (S2) of the crankshaft (CS) of the internal combustion engine (ICE) is greater than or equal to zero.

21. Method according to one of the claims 16 through 20, characterized in that the torque (T2) has a negative value when the speed (S1) of the electric machine (S/G) is negative, the speed (S2) of the crankshaft (CS) of the internal combustion engine (ICE) is greater than or equal to zero, and the torque (T3) is less than a specified value.

22. Method according to one of the claims 16 through 21, characterized in that the negative value of the torque (T2) is a constant value.

23. Method according to one of the claims 16 through 22, characterized in that, when the speed (S1) of the electric machine (S/G) is negative, the torque (T2) is brought to a positive value when the speed (S2) of the crankshaft is less than zero.

24. Method according to one of the claims 16 through 23, characterized in that a model calculation is used to estimate the torque (T3) that takes into account the speed (S2) of the crankshaft (CS) of the internal combustion engine (ICE), the speed (S1) of the electric machine (S/G), and the characteristic curve of the spring of the spring-and-damper assembly (S/D).
